(19) United States
(12) Patent Application Publication
(10) Pub. No.: US 2011/0200877 A1
(43) Pub. Date: Aug. 18, 2011

(54) NON-AQUEOUS ELECTROLYTE SECONDARY BATTERY

(75) Inventors: Nobuhiro Sakitani, Itano-gun (JP); Hroshi Minami, Kobe-shi (JP); Hiroyuki Fujimoto, Kobe-shi (JP)

(73) Assignee: SANYO ELECTRIC CO., LTD., Osaka (JP)

(21) Appl. No.: 13/028,701

(22) Filed: Feb. 16, 2011

(30) Foreign Application Priority Data
Feb. 17, 2010 (JP) 2010-032036
Dec. 17, 2010 (JP) 2010-281197

(51) Int. Cl. H01M 4/13; H01M 4/131

(52) U.S. Cl. 429/218.1; 429/231.3

(57) ABSTRACT

A non-aqueous electrolyte secondary battery has a positive electrode (17) containing positive electrode active material, a negative electrode containing a negative electrode active material, a non-aqueous electrolyte, and a separator (18) disposed between the positive electrode (17) and the negative electrode. An inorganic particle layer (19) containing inorganic particles is formed between the positive electrode (17) and the separator (18), and the inorganic particle layer (19) contains a chelating agent (15) that forms a complex with transition metal ions.

### BACKGROUND OF THE INVENTION

1. Field of the Invention

The present invention relates to improvements in non-aqueous electrolyte secondary batteries, such as lithium-ion batteries and polymer batteries, and more particularly to a battery structure that is excellent in storage performance at high temperature and that exhibits high reliability even with a high capacity battery configuration.

2. Description of Related Art

Mobile information terminal devices such as mobile telephones, notebook computers, and PDAs have become smaller and lighter at a rapid pace in recent years. This has led to a demand for higher capacity secondary batteries as the drive power source for the mobile information terminal devices. Non-aqueous electrolyte secondary batteries, which have high energy density among secondary batteries, have achieved higher capacity year by year. However, the power consumption of the mobile information terminals has been increasing, as they tend to have increasing numbers of features and functions. Accordingly, there is a strong demand for a non-aqueous electrolyte secondary battery with higher capacity and higher performance such that it can enable the devices to operate for longer hours at high output power.

Conventionally, the research and development efforts to improve the capacity of the non-aqueous electrolyte secondary batteries have centered around thickness reduction of the components that do not relate to the power-generating element, such as battery can, separator, and current collector (aluminum foil or copper foil), as well as increasing of the filling density of active material (improvements in electrode filling density). These techniques, however, seem to be approaching their limits, and fundamental improvements such as finding alternative materials have become necessary to achieve higher capacity. On the other hand, regarding the attempts to increase the battery capacity using alternative active materials, there are few candidate materials for positive electrode active materials that are comparable or superior to the state-of-the-art lithium cobalt oxide in terms of capacity and performance.

The theoretical capacity of lithium cobalt oxide is about 273 mAh/g. However, when the end-of-charge voltage of the battery is set at 4.2 V, only up to about 160 mAh/g of the capacity is utilized by the battery. Accordingly, when the end-of-charge voltage is raised to 4.4 V (vs. Li/Li⁺), it becomes possible to use up to about 190 mAh/g of the capacity. As a result, about 10% increase in the overall battery capacity can be accomplished.

However, when lithium cobalt oxide is used at a high voltage, the oxidation power of the charged positive electrode active material increases. Consequently, the decomposition of the electrolyte solution is accelerated. Moreover, the delithiated positive electrode active material itself loses stability of the crystal structure, resulting in disintegration of the crystal. This leads to the problems of cycle life deterioration and battery performance deterioration during storage. The battery performance deterioration is especially noticeable in the storage test under high temperature. Although the details of the cause are unclear, the decomposition product of the electrolyte solution and the deposition of the transition metal element (cobalt [Co] when lithium cobalt oxide is used) on the negative electrode surface, which has been dissolved away from the positive electrode active material, are observed in the battery that has deteriorated in the storage test under high temperature. According to a study by the present inventors, such deposition of a transition metal element or a compound containing the transition metal element on the negative electrode greatly hinders ion transport from the negative electrode, and it is believed that this is a primary cause of the capacity loss and the internal resistance increase during high-temperature storage.

Furthermore, since the instability of the crystal structure is worsened when the end-of-charge voltage is raised as described above, the foregoing phenomena tend to occur more noticeably even at a temperature in the vicinity of 50° C., at which the battery systems with an end-of-charge voltage of 4.2 V have not caused the problems.

For example, in the case of the battery system with an end-of-charge voltage of 4.4 V with a combination of the active materials lithium cobalt oxide and graphite, the remaining capacity decreases considerably, in some cases to nearly zero, when a storage test is conducted under the conditions at 60° C. for 5 days. Following the disassembly of the tested battery, a large amount of cobalt was found in the negative electrode and the separator. This is believed to indicate that above-described mode of deterioration is accelerated especially when the charge voltage is set high. The reason is believed to be as follows. The valency of the transition metal element increases by the extraction of lithium ions. However, since tetravalent cobalt is unstable, the crystal structure thereof does not become stable and tends to change into a more stable structure. Consequently, the cobalt ions tend to dissolve away from the crystals easily. As described above, when the charged positive electrode active material has an unstable structure, the performance deterioration during storage and the cycle life degradation under high temperature conditions tend to be more evident. It has been found that such problems arise more easily when the filling density of the positive electrode is higher, so the problems are more serious in the case of batteries designed to have a high capacity with an increased electrode filling density.

When a spinel-type lithium manganese oxide is used as the positive electrode active material, manganese (Mn) or the like dissolves away from the positive electrode active material even if the end-of-charge voltage is 4.2 V, and the manganese or the like that has dissolved away results in cycle life degradation and battery deterioration during storage.

The following methods (1) through (5) that use a chelating functional group for trapping transition metal ions by forming coordinate bonds have been proposed as the techniques for selectively trapping the transition metals such as manganese and cobalt.

(1) Japanese Published Unexamined Patent Application No. H11-121012 discloses a method in which a chelating polymer is contained in at least one of the positive electrode, the negative electrode, and the separator. It also proposes that when a chelating polymer is contained in the separator, a chelating resin film is disposed on at least one surface of a commonly-used microporous polyethylene film or the like, in addition to the configuration in which the separator itself is made of a chelating polymer.

(2) Japanese Published Unexamined Patent Application No. 2000-195553 discloses a method in which a chelating agent, a chelating resin, or the like is added to at least one electrode selected from the positive and negative electrodes in a secondary battery that uses a manganese-system positive electrode.

(3) Japanese Published Unexamined Patent Application No. 2004-63123 discloses a method in which a chelating agent is added to the binder, the separator, and the electrolyte.

(4) Japanese Published Unexamined Patent Application No. 2007-207690 discloses a method in which a chelating agent for coupling with copper ions is chemically bonded to the separator.

(5) Published Japanese Translation of PCT Application No. 2009-517836 discloses a method in which a chelating agent is added to the electrolyte.

However, in the case of adding the chelating agent to the negative electrode, the electrolyte, or the separator, the chelating agent may form a complex with transition metal ions but it may be reduced on the negative electrode, causing the transition metal to deposit thereon. In particular, when the chelating agent is contained inside the negative electrode, the transition metal ions that migrate from the positive electrode side deposit predominantly on the negative electrode surface. Consequently, there has been a problem that the effect of the addition of the chelating agent cannot be obtained easily, so the deterioration during storage at high temperature and the cycle life degradation cannot be inhibited.

Moreover, in carboxylic groups, amino groups, and the like that are contained commonly in the chelating agents, electrons are localized; therefore, they have low oxidative stability and low reduction stability. As a consequence, when a chelating agent is added into the positive electrode that reaches a high potential, the chelating agent undergoes an oxidative decomposition and generates a gas, as will be detailed in the later-described Reference Experiment. This results in a considerable battery thickness increase during high-temperature storage. Also, part of the decomposition product covers the positive electrode and hinders insertion and release of lithium ions. Consequently, problems arise that the battery resistance increases after high-temperature storage, and that the charge-discharge efficiency deteriorates. Moreover, due to the gas generation, the battery internal pressure rises, causing the gas to be released outside the battery, which may impair the reliability of the battery.

In addition, when a chelating agent is added into the positive electrode and cobalt or the like dissolves away from the positive electrode active material, a majority of the cobalt or the like that has dissolved away from the positive electrode active material particles located near the positive electrode current collector can be trapped by the chelating agent; however, the cobalt or the like that has dissolved away from the positive electrode active material particles located near the positive electrode surface is often not trapped by the chelating agent.

The reason is as follows. As illustrated in FIG. 2, when the cobalt or the like dissolves away from positive electrode active material particles 12 located in the vicinity of a positive electrode current collector 11, the distance by which the cobalt or the like moves in the positive electrode to a positive electrode surface 13 is long, so the probability that the a chelating agent 15 exists within the distance is high. On the other hand, when the cobalt or the like dissolves away from positive electrode active material particles 14 that are located in the vicinity of a positive electrode surface 13, the distance by which the cobalt or the like moves in the positive electrode to a positive electrode surface 13 is short, so the probability that the a chelating agent 15 exists within the distance is low.

Accordingly, in order to trap the cobalt or the like that has dissolved away from the positive electrode active material particles 14 that are located near the positive electrode surface 13 also by the chelating agent 15, it is necessary to increase the proportion of the chelating agent within the positive electrode. Nevertheless, if the proportion of the chelating agent is increased, the relative proportion of the positive electrode active material becomes less in the positive electrode, reducing the battery capacity per unit volume.

Furthermore, in the method in which the separator and the chelating resin film are layered, as in Japanese Published Unexamined Patent Application No. H11-121012, lithium ion conductivity is significantly lowered because the chelating resin film inherently passes through only metal ions and does not pass through the solvent. In addition, the chelating resin film has a thickness equal to or greater than the thickness of the separator commonly used for non-aqueous electrolyte secondary batteries (10 μm to 30 μm), so the distance between the electrodes becomes longer and the resistance to lithium ion conduction becomes greater. Consequently, the charge-discharge efficiency is lowered.

### BRIEF SUMMARY OF THE INVENTION

Accordingly, it is an object of the present invention to provide a non-aqueous electrolyte secondary battery that shows excellent high-temperature storage performance, that inhibits the battery resistance increase and the charge-discharge efficiency degradation after storage, and moreover that has a high capacity with improved reliability.

In view of the foregoing and other problems, the present invention provides a non-aqueous electrolyte secondary battery comprising: a positive electrode containing a positive electrode active material; a negative electrode containing a negative electrode active material; a non-aqueous electrolyte; a separator disposed between the positive electrode and the negative electrode; and an inorganic particle layer containing inorganic particles, the inorganic particle layer disposed between the positive electrode and the separator and/or between the negative electrode and the separator and containing a chelating agent forming a complex with transition metal ions.

The present invention makes it possible to improve the high-temperature storage performance of the battery and at the same time prevent the battery resistance increase and the charge-discharge efficiency degradation after storage. Moreover, the invention can increase the capacity of the non-aqueous electrolyte secondary battery while improving the reliability of the battery.

### BRIEF DESCRIPTION OF THE DRAWINGS

FIG. 1 is a partial cross-sectional view of a non-aqueous electrolyte secondary battery according to an embodiment of the present invention; and

FIG. 2 is a partial cross-sectional view of a conventional non-aqueous electrolyte secondary battery.

### DESCRIPTION OF EMBODIMENTS

The present invention provides a non-aqueous electrolyte secondary battery comprising a positive electrode containing a positive electrode active material, a negative electrode containing a negative electrode active material, a non-aqueous electrolyte, and a separator disposed between the positive electrode and the negative electrode. An inorganic particle layer containing inorganic particles is disposed between the positive electrode and the separator and/or between the negative electrode and the separator. The inorganic particle layer contains a chelating agent forming a complex with transition metal ions.

When the chelating agent is contained in the inorganic particle layer disposed between the positive electrode and the separator and/or between the negative electrode and the separator, the chelating agent barely comes into contact directly with the electrodes (i.e., with the positive electrode active material or the negative electrode active material). As a result, the feature of the chelating agent, that transition metals such as manganese and cobalt can be trapped selectively, can be exhibited sufficiently while avoiding common problems with the chelating agent, such as poor oxidative stability and poor reductive stability can be avoided.

Specifically, since the chelating agent is contained in the inorganic particle layer, the chelating agent forms a complex with transition metal ions in the layer, preventing the transition metals from depositing on the negative electrode surface. Moreover, although the chelating agent is poor in oxidative stability and reductive stability, such a problem as the oxidative decomposition of the chelating agent can be prevented by the above-described configuration because the possibility that the positive electrode and the chelating agent come into direct contact with each other can be made lower than such a case that the chelating agent is added into the positive electrode with a high potential. Accordingly, the constraints relating to the oxidative stability and reductive stability are less, and a wide range of choice for the chelating material is possible (for example, it becomes possible to choose a chelating agent that is highly capable of trapping transition metals such as cobalt but tends to cause oxidative decomposition or reductive decomposition easily). Furthermore, the gas generation within the battery is inhibited, so the deterioration in reliability resulting from the release of the generated gas to outside the battery can be avoided.

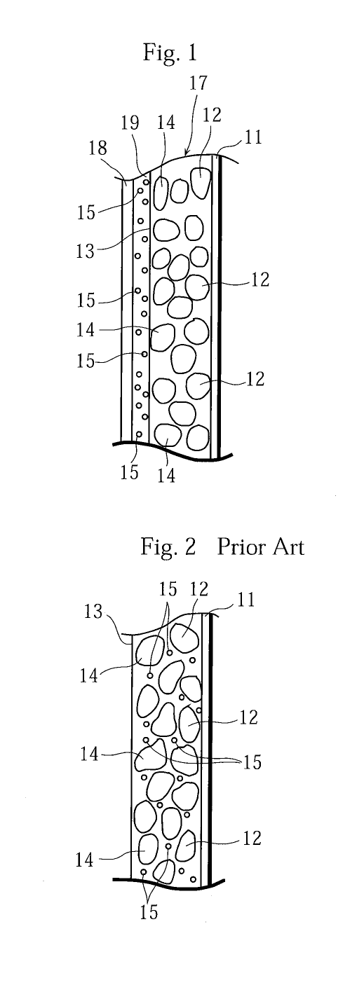

In addition, when the inorganic particle layer 19 containing the chelating agent is disposed between the separator 18 and the positive electrode 17, for example, as illustrated in FIG. 1, the chelating agent 15 exists between the surface of the positive electrode 17 and the surface of the negative electrode (not shown). As a result, even when cobalt or the like dissolves away from the positive electrode active material particles 14 located in the vicinity of the positive electrode surface 13 as well as from the positive electrode active material particles 12 located in the vicinity of the positive electrode current collector 11, the cobalt or the like is trapped by the chelating agent 15. This eliminates the need for providing a large amount of chelating agent 15 inside the battery. As a result, the problem of the battery capacity deterioration per unit volume can be resolved. The same advantageous effect can be obtained also when the inorganic particle layer 19 containing the chelating agent 15 is disposed between the separator 18 and the negative electrode.

What is more, the chelating agent is added in the inorganic particle layer (in other words, it is different from forming a chelating resin film consisting of chelating resin only), and therefore, it is possible to inhibit the lithium ion conductivity from being hindered greatly. Furthermore, it is possible to make the thickness of the inorganic particle layer less than the thickness of the commonly-used separator for non-aqueous electrolyte secondary batteries (10 μm to 30 μm). As a result, it is possible to prevent the decrease of lithium ion conductivity that is caused by the increase of the distance between the electrodes.

Thus, the features of the chelating agent, i.e., trapping the transition metal ions that dissolve away from the positive electrode and preventing the transition metal ions from depositing on the negative electrode surface, can be exhibited fully by addition of a small amount of the chelating agent.

It is desirable that the inorganic particle layer be disposed between the positive electrode and the separator.

The reason is that the transition metal ions can be trapped more efficiently when the chelating agent is placed in the vicinity of the positive electrode, which is the source from which the transition metal ions dissolve away. Moreover, when such an arrangement is employed, the positive electrode and the separator do not come into direct contact with each other. Therefore, even when polyethylene, for example, is used for the separator, the separator can be prevented from the alteration in quality resulting from oxidation of the separator and from the deterioration in separator strength resulting from the alteration in quality.

It is desirable that the inorganic particle layer be disposed on a surface of the positive electrode.

When heat generation takes place inside the battery, the sheet-shaped separator can shrink. When the inorganic particle layer is formed on the surface of the separator, the inorganic particle layer may also shrink together with the separator. This problem can be avoided when the inorganic particle layer is formed on the positive electrode surface.

It is desirable that the amount of the chelating agent be from 0.1 mass % to 2.0 mass % based on the mass of the inorganic particles.

If the amount of the chelating agent exceeds 2.0 mass % with respect to the amount of the inorganic particles, the porosity in the inorganic particle layer is so low that the lithium ion transport between the positive and negative electrodes can be hindered, and consequently, the high-rate capability may deteriorate. On the other hand, if the amount of the chelating agent is less than 0.1 mass % with respect to the amount of the inorganic particles, the amount of the chelating agent is too small to obtain the advantageous effect by the addition of the chelating agent sufficiently.

It is desirable that the inorganic particles have an average particle size greater than the average pore size of the separator.

When the average particle size of the inorganic particles is greater than the average pore size of the separator, the inorganic particles are inhibited from entering the micropores in the separator, and the resulting deterioration in discharge performance can be avoided.

It is desirable that the inorganic particles have an average particle size of from 0.1 μm to 1 μm.

If the average particle size of the inorganic particles exceeds 1 μm, the thickness of the inorganic particle layer may be too great. On the other hand, if the average particle size of the inorganic particles is less than 0.1 μm, the dispersibility of the inorganic particles in the slurry may be too low. Taking the foregoing into consideration, it is more preferable that the average particle size of the inorganic particles be within the range of from 0.1 μm to 0.8 μm.

In order to enhance the dispersibility in the slurry, it is particularly preferable that the surfaces of the inorganic particles be coated with aluminum, silicon, or titanium.

It is desirable that the inorganic particles comprise at least one substance selected from the group consisting of rutile-type titania (rutile-type titanium oxide) and alumina (aluminum oxide).

These substances show excellent stability inside the battery (i.e., low reactivity with lithium) and moreover are available at low cost. The reason why the rutile-type titania is employed is as follows. The anatase-type titania is capable of insertion and deinsertion of lithium ions, and therefore it can absorb lithium and exhibit electron conductivity, depending on the surrounding atmosphere and or the potential, so there is a risk of capacity degradation and short circuiting.

However, the materials for the inorganic particles are not limited to these substances, but it is also possible to use zirconia (zirconium oxide), magnesia (magnesium oxide), and the like.

It is desirable that the inorganic particle layer have a thickness of from 0.5 μm to 4 μm per one side.

If the thickness of the inorganic particle layer is less than 0.5 μm, the amount of the chelating agent contained in the inorganic particle layer may be too small to obtain the above-described advantageous effects. On the other hand, if the thickness of the inorganic particle layer exceeds 4 μm, the high-rate capability of the battery may degrade because the distance between the electrodes becomes too long, or the energy density may decrease because the amounts of the positive and negative electrode active materials become too small. Taking the foregoing into consideration, it is particularly preferable that the thickness of the inorganic particle layer be within the range of from 0.5 μm to 2 μm.

It is desirable that the positive electrode have a filling density of 3.40 g/cm³ or greater.

The reason is that when the positive electrode has a filling density of 3.40 g/cm³ or greater, the positive electrode capacity per unit volume can be sufficiently high. When the filling density of the positive electrode becomes higher, the amount of the transition metals such as manganese and cobalt that dissolve away from the positive electrode may become greater correspondingly. However, the chelating agent placed in the inorganic particle layer can selectively trap these transition metals.

### Other Embodiments

(1) Any kind of chelating agent may be used for the present invention as long as the chelating agent does not react or form coordinate bond with lithium ions and the chelating agent forms a complex with transition metal ions in the battery. Examples include EDTA (ethylenediaminetetraacetic acid), NTA (nitrilotriacetic acid), DCTA (trans-1,2-diaminocyclohexanetetraacetic acid), DTPA (diethylene-triamine pentaacetic acid), and EGTA (bis-(aminoethyl)glycolether-N,N,N′,N′-tetraacetic acid). All of these chelating agents have carboxyl groups, and they have in common that the oxygen in the carboxyl groups can stabilize and trap the cations of the transition metal ions. It should be noted that although the oxygen portion of the carboxyl groups is rather poor in oxidative stability and reductive stability, the above-described configuration can prevent the chelating agent from undergoing oxidative decomposition because the high-potential positive electrode and the chelating agent do not come in direct contact with each other.

(2) The inorganic particle layer contains a binder for binding the inorganic particles to each other, but the material of the binder is not limited. However, it is preferable that the binder satisfy the following characteristics.

[a] Ensuring dispersion capability of the inorganic particles (for preventing re-aggregation).

[b] Ensuring adhesion capability that enables the inorganic particles to withstand the manufacturing process of the battery.

[c] Filling the gaps between the inorganic particles resulting from the expansion after absorbing the non-aqueous electrolyte.

[d] Causing less dissolution into the non-aqueous electrolyte.

Examples of the binders that satisfy such characteristics include polytetrafluoroethylene (PTFE), polyacrylonitrile (PAN), styrene-butadiene rubber (SBR), modified substances thereof, derivatives thereof, copolymers containing acrylonitrile units, and polyacrylic acid derivatives.

In order to ensure sufficient battery performance, it is preferable that these effects can be obtained with a small amount of the binder. For this reason, it is preferable that the amount of the binder in the inorganic particle layer be 30 mass % or less, more preferably 10 mass % or less, and still more preferably 5 mass % or less, based on the total amount of the inorganic particles and the dispersing agent. The lower limit of the amount of the binder in the inorganic particle layer is generally 0.1 mass % or greater.

(3) When an organic solvent such as NMP is used as the solvent for the slurry in preparing an electrode plate (mainly in the case of preparing the positive electrode), it is preferable that water be used as the solvent for the slurry that is used for forming the inorganic particle layer. Although the use of an organic solvent such as NMP as the solvent for the slurry for forming the inorganic particle layer allows the resulting slurry to have good dispersion stability, it has a disadvantage that the organic solvent and the binder diffuse inside the electrode plate, causing the binder in the electrode plate to swell, and consequently, the energy density decreases. In addition, when water is used as the solvent for the slurry, an environmental load can be reduced. When water is used as the solvent for the slurry in preparing an electrode plate (mainly in the case of preparing the negative electrode), it is preferable that an organic solvent such as NMP be used as the solvent for the slurry that is used for forming the inorganic particle layer. This is to prevent water and the binder from diffusing inside the electrode plate and causing the binder in the electrode plate to swell, and thereby prevent the deterioration of the energy density. A suitable method for dispersing the slurry is a wet-type dispersion technique such as a technique using a bead mill or a Filmics mixer made by Tokushu Kika. In particular, since the particle size of the inorganic particles used in the present invention is small, sedimentation in the slurry is significant and it is impossible to form a uniform film unless they are subjected to a mechanical dispersion process. For this reason, a dispersion technique used for dispersing a paint may be used preferably.

Examples of the methods for forming the inorganic particle layer on the surface of the positive electrode and/or the negative electrode include die coating, gravure coating, dip coating, curtain coating, and spray coating. Gravure coating and die coating are especially preferable. Taking the decrease of bonding strength caused by the diffusion of the solvent or the binder into the electrode into consideration, it is desirable to use a technique that is capable of high speed coating and that requires a shorter drying time. The solid content in the slurry may vary greatly depending on the technique of coating. For the spray coating, dip coating, and curtain coating, in which the thickness of coating is difficult to control mechanically, it is preferable to use a slurry with a low solid content be low. More specifically, it is preferable that the solid content be within the range of from 3 mass % to 30 mass %. On the other hand, for die coating, gravure coating, and the like, the solid content may be high. Therefore, the solid content may preferably be about 5 mass % to 70 mass %.

(4) In the present invention, it is preferable that the non-aqueous electrolyte secondary battery be charged so that the end-of-charge potential of the positive electrode is higher than 4.30 V (vs. Li/Li⁺). By charging the battery so that the end-of-charge potential of the positive electrode becomes higher than that with the conventional cases, the charge-discharge capacity can be increased. By raising the end-of-charge potential of the positive electrode, the transition metals such as manganese and cobalt tend to dissolve away more easily from the positive electrode active material. However, according to the present invention, the chelating agent contained in the inorganic particle layer can selectively trap these transition metals, as described above. As a result, it becomes possible to prevent the deterioration of the high-temperature storage performance resulting from the deposition of the transition metals on the negative electrode surface.

In the present invention, it is more preferable that the non-aqueous electrolyte secondary battery be charged so that the end-of-charge potential of the positive electrode is set at 4.35 V (vs. Li/Li⁺) or higher, still more preferably 4.40 V (vs. Li/Li⁺) or higher. When a carbon material is used as the negative electrode active material, the end-of-charge potential of the negative electrode is about 0.1 V (vs. Li/Li⁺). Accordingly, when the end-of-charge potential of the positive electrode is 4.30 V (vs. Li/Li⁺), the end-of-charge voltage is 4.20 V, and when the end-of-charge potential of the positive electrode is 4.40 V (vs. Li/Li⁺), the end-of-charge voltage is 4.30 V.

The non-aqueous electrolyte secondary battery of the present invention has excellent high-temperature storage performance. For example, when the invention is applied to a non-aqueous electrolyte secondary battery that is operated in an environment at 50° C. or higher, the advantageous effects of the invention can be exhibited significantly.

(5) For the positive electrode active material used in the present invention, a lithium-containing transition metal oxide having a layered structure is preferable. Examples of the lithium-transition metal oxide include lithium cobalt oxide, lithium nickel oxide, lithium-cobalt-nickel-manganese composite oxide, lithium-nickel-cobalt-aluminum composite oxide, and lithium-nickel-manganese-aluminum composite oxide. These positive electrode active materials may be used either alone or in combination with other positive electrode active materials.

(5) The negative electrode active material used in the present invention is not particularly limited, and any kind of active material may be used as long as it can be used as the negative electrode active material for non-aqueous electrolyte secondary batteries. Examples of the negative electrode active material include carbon materials such as graphite and coke, metal oxides such as tin oxide, metals such as silicon and tin that can absorb lithium by alloying with lithium, and metallic lithium. Carbon materials such as graphite are particularly preferable for the negative electrode active material in the present invention.

(7) The solvent for the non-aqueous electrolyte used in the present invention may be any solvent that has conventionally been used as a solvent for an electrolyte in lithium secondary batteries. Particularly preferable is a mixed solvent of a cyclic carbonate and a chain carbonate. More specifically, it is preferable that the mixing ratio of the cyclic carbonate and chain carbonate be set within the range of 1:9 to 5:5 (cyclic carbonate: chain carbonate).

Examples of the cyclic carbonate include ethylene carbonate, fluoroethylene carbonate, propylene carbonate, butylene carbonate, and vinylene carbonate. Examples of the chain carbonate include dimethyl carbonate, methyl ethyl carbonate, and diethyl carbonate. It is particularly preferable that fluoroethylene carbonate be contained as the cyclic carbonate. It is also possible to use a mixed solvent of one of the above-mentioned cyclic carbonates and an ether-based solvent such as 1,2-dimethoxyethane or 1,2-diethoxyethane.

Examples of the solute in the non-aqueous electrolyte usable in the present invention include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiClO₄, Li₂B₁₀Cl₁₀, Li₂B₁₂Cl₁₂, and mixtures thereof. A particularly preferable example is at least one substance selected from the group consisting of LiXF_{y} (wherein: X is P, As, Sb, B, Bi, Al, Ga, or In; and y is 6 when X is P, As, or Sb, or y is 4 when X is B, Bi, Al, Ga, or In), lithium perfluoroalkylsulfonic imide LiN(CₘF₂ₘ₊₁SO₂)(CₙF₂ₙ₊₁SO₂) (wherein m and n denote, independently of one another, integers from 1 to 4), and lithium perfluoroalkylsulfonic methide LiC(CₚF₂ₚ₋₁SO₂)(C_{q}F_{2q+1}SO₂)(CᵣF₂ᵣ₊₁SO₂) (wherein p, q, and r denote, independently of one another, integers from 1 to 4).

It is also possible to use, as the electrolyte, a gelled polymer electrolyte in which an electrolyte solution is impregnated in a polymer electrolyte such as polyethylene oxide and polyacrylonitrile, and an inorganic solid electrolyte such as LiI or Li₃N.

There is no limitation to the electrolyte of the non-aqueous electrolyte secondary battery, and any type of electrolyte may be used as long as the lithium compound used as the solute for providing ionic conductivity and the solvent used for dissolving and retaining the solute are not decomposed at a voltage during charge and discharge or at a voltage during the storage of the battery.

(8) In the non-aqueous electrolyte secondary battery of the present invention, it is preferable that the ratio of the charge capacity of the negative electrode to the charge capacity of the positive electrode (negative electrode charge capacity/positive electrode charge capacity) in a fully-charged state of the battery be within the range of from 1.0 to 1.1. Setting the charge capacity ratio of the negative electrode to the positive electrode to be 1.0 or greater serves to prevent deposition of metallic lithium on the negative electrode surface. As a result, the cycle performance and reliability of the battery can be enhanced. If the charge capacity ratio of the negative electrode to the positive electrode exceeds 1.1, the energy density per volume may undesirably decrease. Note that such a charge capacity ratio of the negative electrode to the positive electrode is set corresponding to the end-of-charge voltage of the battery.

Hereinbelow, examples of the non-aqueous electrolyte secondary battery according to the present invention are described in detail. It should be construed, however, that the non-aqueous electrolyte secondary battery according to this invention is not limited to the following embodiments and examples but various changes and modifications may be made without departing from the scope of the invention.

### Preparation of Positive Electrode

Lithium cobalt oxide as the positive electrode active material, acetylene black as a carbon conductive agent, and PVDF (polyvinylidene fluoride) as a binder agent were mixed together at a mass ratio of 95:2.5:2.5. Then, using NMP as a solvent, the mixture was mixed with a mixer, to prepare a positive electrode mixture slurry.

The positive electrode mixture slurry was applied onto both sides of an aluminum foil, and then dried. Thereafter, the resultant material was calendered, to prepare a positive electrode. The filling density of the positive electrode was set at 3.60 g/cm³.

### Preparation of Inorganic Particle Layer

First, an aqueous slurry for forming the inorganic particle layer was prepared using the following materials. Water was used as the solvent. Titanium oxide (TiO₂, average particle size: 0.25 μm, no surface coating layer, made by Ishihara Sangyo Co., Ltd. under the trade name “CR-EL”) was used as the inorganic particles. CMC (made by Daicel Chemical Industries, Ltd., item number “1380”) was used as a dispersion stabilizer. SBR (styrene-butadiene rubber) was used as an aqueous binder. Ethylenediaminetetraacetic acid was used as the chelating agent. The solid content of the inorganic particles was set at 30 mass %. The amounts of the dispersion stabilizer, the binder, and the chelating agent were set at 0.2 mass %, 3.8 mass %, and 1.9 mass %, respectively, based on the mass of the inorganic particles.

Next, the prepared aqueous slurry was coated on both sides of the positive electrode by gravure coating, and thereafter, water, serving as the solvent, was removed by drying. Thus, inorganic particle layers were formed on both sides of the positive electrode. The thickness of the inorganic particle layer was set at 2 μm on each side (a total of 4 μm on both sides).

### Preparation of Negative Electrode

First, artificial graphite, CMC (made by Daicel Chemical Industries, Ltd., item number “1380”) dissolved in pure water at a concentration of 1 mass %, and SBR were mixed so that the mass ratio of the solid contents became 98:1:1. The mixture was kneaded using a T.K. COMBI MIX mixer made by Tokushu Kika to prepare a negative electrode mixture slurry. Next, the resultant negative electrode mixture slurry was applied onto both sides of a copper foil and then dried. Thereafter, the resultant material was calendered, to prepare a negative electrode. The filling density of the negative electrode was set at 1.60 g/cm³.

### Preparation of Non-Aqueous Electrolyte Solution

A lithium salt LiPF₆ was dissolved at a concentration of 1.0 mole/L in a mixed solvent of 3:7 volume ratio of ethylene carbonate (EC) and diethyl carbonate (DEC) to prepare a non-aqueous electrolyte solution.

### Construction of Battery

Respective lead terminals were attached to the positive and negative electrodes, and they were spirally wound with separators (each made of polyethylene and having a film thickness of 16 μm and a porosity of 47%) interposed therebetween. These were pressed into a flat shape to prepare an electrode assembly. Thereafter, the electrode assembly was placed in the space formed by aluminum laminate films. Next, the non-aqueous electrolyte solution was filled in the space, and thereafter, the aluminum laminate films were sealed by welding together, to thus prepare a battery. The design capacity of this battery is 850 mAh when the end-of-charge voltage is set at 4.38 V.

### EXAMPLES

### Main Experiments

### Example 1

A battery was fabricated in the same manner as described in the just-described embodiment.

The battery fabricated in this manner is hereinafter referred to as Battery A1 of the invention.

### Example 2

A battery was fabricated in the same manner as described in Example 1 above, except that, in preparing the inorganic particle layers on the positive electrode surfaces, the amount of the chelating agent was set at 3.8 mass % based on the mass of the inorganic particles.

The battery fabricated in this manner is hereinafter referred to as Battery A2 of the invention.

### Example 3

A battery was fabricated in the same manner as described in Example 1 above, except that no inorganic particle layer was formed on the positive electrode surfaces and that inorganic particle layers were formed on the negative electrode surfaces in the following manner.

First, an NMP-based slurry for forming the inorganic particle layers was prepared using the following materials. NMP was used as the solvent. Titanium oxide (TiO₂, average particle size: 0.25 μm, no surface coating layer, made by Ishihara Sangyo Co., Ltd. under the trade name “CR-EL”) was used as the inorganic particles. PVDF (polyvinylidene fluoride) was used as an NMP-based binder. Ethylenediaminetetraacetic acid was used as the chelating agent. The solid content of the inorganic particles was set at 30 mass %. The amounts of the binder and the chelating agent were set at 3.5 mass % and 1.9 mass %, respectively, based on the mass of the inorganic particles. Next, the prepared NMP-based slurry was coated on both sides of the negative electrode by gravure coating in a similar manner to that described in Example 1, and thereafter, NMP, serving as the solvent, was removed by drying. Thus, inorganic particle layers were formed on both sides of the negative electrode. The thickness of the inorganic particle layer was set at 2 μm on each side (a total of 4 μm on both sides).

The battery fabricated in this manner is hereinafter referred to as Battery A3 of the invention.

### Example 4

A battery was fabricated in the same manner as described in Example 3 above, except that, in preparing the inorganic particle layers on the negative electrode surfaces, the amount of the chelating agent was set at 3.8 mass % based on the mass of the inorganic particles.

The battery fabricated in this manner is hereinafter referred to as Battery A4 of the invention.

### Comparative Example 1

A battery was fabricated in the same manner as described in Example 1 above, except that no inorganic particle layer was formed on the positive electrode surfaces (i.e., no chelating agent was provided in the battery).

The battery fabricated in this manner is hereinafter referred to as Comparative Battery Z1.

### Comparative Example 2

A battery was prepared in the same manner as described in Example 1, except that no chelating agent was added to the inorganic particle layers on the positive electrode surfaces.

The battery fabricated in this manner is hereinafter referred to as Comparative Battery Z2.

### Comparative Example 3

A battery was prepared in the same manner as described in Example 3, except that no chelating agent was added to the inorganic particle layers on the negative electrode surfaces.

The battery fabricated in this manner is hereinafter referred to as Comparative Battery Z3.

### Experiment 1

The high-temperature storage performance (the remaining capacity ratio and the battery swelling amount after storage under high temperature) was determined for each of Batteries A1 to A4 of the invention and Comparative Batteries Z1 to Z3. The results are shown in Table 1 below.

Specifically, each of the batteries was charged at a constant current of 1.0 It (850 mA) until the battery voltage reached a predetermined voltage (4.38 V), and thereafter charged at the predetermined voltage until the current value reached 1/20 It (42.5 mA). Next, each battery was set aside for 10 minutes and thereafter discharged at a constant current of 0.2 It (170 mA) until the battery voltage reached 3.00 V. Then, the discharge capacity (pre-storage discharge capacity) at that point was measured for each battery.

Next, each of the batteries was charged at a constant current of 1.0 It (850 mA) until the battery voltage reached a predetermined voltage (4.38 V), and thereafter charged at the predetermined voltage until the current value reached 1/20 It (42.5 mA). Thereafter, each battery was stored in a thermostatic chamber at 60° C. for 20 days. Thereafter, each battery was further discharged at a constant current of 0.2 It (170 mA) until the battery voltage reached 3.00 V. Then, the discharge capacity (post-storage discharge capacity) at that point was measured for each battery.

Then, the remaining capacity ratio after high-temperature storage (which may be simply referred to as the remaining capacity ratio hereinafter) was determined for each battery according to the following equation (1). The battery swelling amount for each battery was determined from the following equation (2).

### [Determination of Remaining Capacity Ratio]

Remaining capacity ratio (%)=(Post-storage discharge capacity/Pre-storage discharge capacity)×100 Eq. (1)

### [Determination of Battery Swelling Amount]

Battery swelling amount=Battery thickness after storage−Battery thickness before storage Eq. (2)

TABLE 1

| | Presence or absence | Amount of | | |
|---|---|---|---|---|
| | of inorganic particle | chelating | Remaining | Battery |
| | layer and the | agent | capacity | swelling |
| Battery | location of the layer | added | ratio | amount |
| A1 | Present | 1.9 mass % | 63.1% | Δ0.088 mm |
| A2 | (positive electrode | 3.8 mass % | 59.5% | Δ0.070 mm |
| | surface) | | | |
| A3 | Present | 1.9 mass % | 58.3% | Δ0.095 mm |
| A4 | (negative electrode | 3.8 mass % | 57.0% | Δ0.092 mm |
| | surface) | | | |
| Z1 | Absent | — | 38.3% | Δ0.229 mm |
| Z2 | Present | Not added | 55.9% | Δ0.062 mm |
| | (positive electrode | | | |
| | surface) | | | |
| Z3 | Present | Not added | 50.7% | Δ0.071 mm |
| | (negative electrode | | | |
| | surface) | | | |

The results shown in Table 1 clearly indicate that Comparative Batteries Z2 and Z3, in which inorganic particle layers were provided but no chelating agent was contained, showed higher remaining capacity ratios after high-temperature storage than Comparative Battery Z1, in which no inorganic particle layer was provided (i.e., no chelating agent is provided in the battery). Nevertheless, Comparative Batteries Z2 and Z3 showed lower remaining capacity ratios after high-temperature storage than Batteries A1 to A4 of the invention, in which inorganic particle layers were provided and also the chelating agent was add to the inorganic particle layer. Moreover, Batteries A1 and A2 of the invention, in which the inorganic particle layers were formed on the positive electrode surfaces, exhibited higher remaining capacity ratios after high-temperature storage than Batteries A3 and A4 of the invention, in which the inorganic particle layers were formed on the negative electrode surfaces. The reason is believed to be as follows. The chelating agent can exist closer to the positive electrode active material, which is the source from which metal ions dissolve away, when the chelating agent is added to the inorganic particle layer on the positive electrode surface than when the chelating agent is added to the inorganic particle layer on the negative electrode surface. As a result, the metal ions can be trapped more efficiently. Thus, it is more preferable that the inorganic particle layer be disposed on a surface of the positive electrode surface (i.e., between the positive electrode and the separator).

The battery swelling amount after high-temperature storage was less than 0.100 mm for all of Batteries A1 to A4 of the invention as well as Comparative Batteries Z2 and Z3, so all of them were able to inhibit the battery swelling amount after high-temperature storage sufficiently. In contrast, the battery swelling amount of Comparative Battery Z1 was very large, greater than 0.200 mm.

### Experiment 2

In order to investigate the reason why Batteries A1 and A2 of the invention exhibit improved high-temperature storage performance over Comparative Batteries Z1 and Z2, the amount of deposited cobalt on the negative electrode was determined for each battery in the following technique. The results are shown in Table 2 below.

After the remaining capacity after high-temperature storage was measured, 5 g of the negative electrode active material decomposed and taken out in an argon atmosphere was placed in a mixed solution of 20 g of pure water, 2 g of hydrochloric acid, and several drops of hydrogen peroxide solution, and heated for 2.5 hours. The heated solution was cooled and filtered, and the obtained solution was analyzed by ICP to determine the amount of cobalt ions in the solution. Thereby, the amount of cobalt deposited on the negative electrode surface (hereinafter referred to as the “amount of deposited cobalt”) was determined.

TABLE 2

| | Presence or absence of | Amount of | |
|---|---|---|---|
| | inorganic particle layer and | chelating agent | Amount of |
| Battery | the location of the layer | added | deposited cobalt |
| A1 | Present | 1.9 mass % | 549 ppm |
| A2 | (positive electrode surface) | 3.8 mass % | 528 ppm |
| Z1 | Absent | — | 687 ppm |
| Z2 | Present | Not added | 596 ppm |
| | (positive electrode surface) | | |

The results shown in Table 2 clearly indicate that Batteries A1 and A2 of the invention had smaller amounts of deposited cobalt than Comparative Batteries Z1 and Z2. The reason is believed to be as follows. Because the chelating agent is contained in the inorganic particle layer, the chelating agent can trap the cobalt that dissolves away from the positive electrode, and inhibit the deposition of the cobalt (in comparison of Batteries A1 and A2 of the invention with Comparative Batteries Z1 and Z2). Thereby, Batteries A1 and A2 of the invention achieved significantly higher remaining capacity ratios after high-temperature storage than Comparative Batteries Z1 and Z2, as shown in Experiment 1 above.

### Experiment 3

The discharge rate performance of Batteries A1 and A2 of the invention was determined The results are shown in Table 3 below.

Specifically, each of the batteries was charged at a constant current of 1.0 It (850 mA) until the battery voltage reached a predetermined voltage (4.38 V), and thereafter charged at the predetermined voltage until the current value reached 1/20 It (42.5 mA). Next, each battery was set aside for 10 minutes and thereafter discharged at a constant current of 1.0 It (850 mA) until the battery voltage reached 3.00 V. Then, the discharge capacity at that point (the discharge capacity at 1.0 It) was measured for each battery.

Next, each of the batteries was charged at a constant current of 1.0 It (850 mA) until the battery voltage reached a predetermined voltage (4.38 V), and thereafter charged at the predetermined voltage until the current value reached 1/20 It (42.5 mA). Next, each battery was set aside for 10 minutes and thereafter discharged at a constant current of 2.0 It (1700 mA) until the battery voltage reached 3.00 V. Then, the discharge capacity at that point (the discharge capacity at 2.0 It) was measured for each battery. Lastly, the discharge rate ratio for each battery was calculated using the following equation (3).

### Determination of Discharge Rate Capacity Ratio

Discharge rate ratio (%)=(Discharge capacity at 2.0 It/Discharge capacity at 1.0 It)×100 Eq. (3)

TABLE 3

| | Presence or absence of | Amount of | Discharge |
|---|---|---|---|
| | inorganic particle layer and | chelating agent | rate ratio |
| Battery | the location of the layer | added | (2.0 It) |
| A1 | Present | 1.9 mass % | 56.4% |
| A2 | (positive electrode surface) | 3.8 mass % | 36.0% |

The results shown in Table 3 clearly indicate that Battery A1 of the invention showed a higher discharge rate ratio in the discharge at 2.0 It than Battery A2 of the invention. The reason is believed to be as follows. Lithium ion transport between the positive and negative electrodes may be hindered when the amount of the chelating agent contained in the inorganic particle layer is too large. Therefore, lithium ion transport was hindered at a lesser degree in Battery A1 of the invention, in which the amount of the chelating agent added was smaller than that in Battery A2 of the invention. Accordingly, it is preferable that the amount of the chelating agent to be added be 2.0 mass % or less.

### Reference Experiment 1

Reference Experiment 1 below describes that the following experiment was conducted in order to prove that desired battery performance would not be obtained even if the chelating agent used in the above-described Examples was contained inside the positive electrode.

### Reference Example 1

A battery was fabricated in the following manner.

The battery fabricated in this manner is hereinafter referred to as Reference Battery R1.

### Preparation of Positive Electrode

First, lithium cobalt oxide as the positive electrode active material and ethylenediaminetetraacetic acid as the chelating agent were mixed at a mass ratio of 99:1. Next, the resultant mixture, acetylene black as a carbon conductive agent, and PVDF (polyvinylidene fluoride) as a binder agent were mixed together at a mass ratio of 95:2.5:2.5. Then, using NMP as a solvent, the mixture was mixed with a mixer, to prepare a positive electrode mixture slurry.

The prepared positive electrode mixture slurry was applied onto both sides of an aluminum foil, and then dried. Thereafter, the resultant material was calendered, to prepare a positive electrode. The filling density of the positive electrode was set at 3.60 g/cm³.

### Preparation of Negative Electrode

A negative electrode was prepared in the same manner as described in Example 1 above.

### Preparation of Non-Aqueous Electrolyte Solution

LiPF₆ was dissolved at a concentration of 1.0 mole/L in a mixed solvent of 3:7 volume ratio of ethylene carbonate (EC) and methyl ethyl carbonate (MEC), and 2 mass % of vinylene carbonate (VC) as an addition agent was further added thereto. A non-aqueous electrolyte solution was thus prepared.

### Construction of Battery

A battery was constructed in the same manner as described in Example 1 above. The design capacity of this battery is 800 mAh when the end-of-charge voltage is set at 4.40 V.

### Reference Example 2

A battery was prepared in the same manner as described in Reference Example 1, except that the chelating agent, ethylenediaminetetraacetic acid, was not added to the positive electrode when preparing the positive electrode.

The battery fabricated in this manner is hereinafter referred to as Reference Battery R2.

### Experiment

Each of Reference Batteries R1 and R2 was charged at a constant current of 1.0 It (800 mA) until the battery voltage reached a predetermined voltage (4.40 V), and thereafter charged at the predetermined voltage until the current value reached 1/20 It (40.0 mA). Thereafter, each battery was stored in a thermostatic chamber at 60° C. for 20 days. The battery thickness change (battery swelling amount) before and after the storage was measured for Reference Batteries R1 and R2. The results are shown in Table 4 below.

TABLE 4

| | | Addition of | |
|---|---|---|---|
| | Presence or absence of | chelating agent to | Battery |
| Battery | inorganic particle layer | positive electrode | swelling amount |
| R1 | Absent | Yes | Δ2.24 mm |
| R2 | | No | Δ0.49 mm |

The results shown in Table 4 clearly indicate that Reference Battery R1, in which the chelating agent (ethylenediaminetetraacetic acid) was contained in the positive electrode, showed a significantly greater battery swelling amount than Reference Battery R2, in which no chelating agent was contained. The reason is believed to be that when the chelating agent was contained in the positive electrode, the chelating agent underwent oxidative decomposition by being exposed under a high temperature at a high potential, resulting in gas generation.

Thus, it is appreciated that when the chelating agent is contained in the positive electrode, the oxidative decomposition of the chelating agent itself takes place, and that the objectives of the present invention cannot be accomplished, therefore, by allowing the chelating agent to be contained inside the positive electrode.

For reference, although the just-described Reference Battery R2 and the previously-described Comparative Battery Z1 have in common one point that no inorganic particle layer exists and no chelating agent exists in the battery, the two batteries show significantly different battery swelling amounts (0.229 mm for Comparative Battery Z1, in contrast to 0.49 mm for Reference Battery R2). It is believed that this difference resulted from the differences in the non-aqueous electrolyte solution and the design capacity between Batteries R2 and Z1.

### Reference Experiment 2

Reference Experiment 2 below describes that the following experiment was conducted in order to prove that desired battery performance would not be obtained even if the chelating agent used in the above-described Examples was contained inside the negative electrode.

### Reference Example 1

A battery was fabricated in the following manner.

The battery fabricated in this manner is hereinafter referred to as Reference Battery R3.

### Preparation of Positive Electrode

A positive electrode was prepared in the same manner as described in Comparative Example 1 of the Main Experiment above.

### Preparation of Negative Electrode

First, artificial graphite and ethylenediaminetetraacetic acid, serving as the chelating agent, were mixed at a mass ratio of 99:1. Next, CMC (made by Daicel Chemical Industries, Ltd., item number “1380”) dissolved in pure water at a concentration of 1 mass %, and SBR were added to the resultant mixture so that the mass ratio of the solid contents became 98:1:1. The mixture was kneaded using a T.K. COMBI MIX mixer made by Tokushu Kika, to prepare a negative electrode mixture slurry. Next, the resultant negative electrode mixture slurry was applied onto both sides of a copper foil and then dried. Thereafter, the resultant material was calendered, to prepare a negative electrode. The filling density of the negative electrode was set at 1.60 g/cm³.

### Preparation of Non-Aqueous Electrolyte Solution

A non-aqueous electrolyte solution was prepared in the same manner as described in Reference Example 1 of the foregoing Reference Experiment 1.

### Construction of Battery

A battery was constructed in the same manner as described in Reference Example 1 of the foregoing Reference Experiment 1. The design capacity of this battery is 800 mAh when the end-of-charge voltage is set at 4.40 V.

### Reference Example 2

A battery was prepared in the same manner as described in Reference Example 1 above, except that the chelating agent, ethylenediaminetetraacetic acid, was not added to the negative electrode when preparing the negative electrode.

The battery fabricated in this manner is hereinafter referred to as Reference Battery R4.

### Experiment

Each of Reference Batteries R3 and R4 was charged at a constant current of 1.0 It (800 mA) until the battery voltage reached a predetermined voltage (4.40 V), and thereafter charged at the predetermined voltage until the current value reached 1/20 It (40.0 mA). Next, each battery was set aside for 10 minutes and thereafter discharged at a constant current of 0.2 It (160 mA) until the battery voltage reached 3.00 V. Then, the discharge capacity (pre-storage discharge capacity) at that point was measured for each battery.

Next, each of the batteries was charged at a constant current of 1.0 It (800 mA) until the battery voltage reached a predetermined voltage (4.40 V), and thereafter charged at the predetermined voltage until the current value reached 1/20 It (40.0 mA). Thereafter, each battery was stored in a thermostatic chamber at 60° C. for 20 days. Thereafter, each battery was further discharged at a constant current of 0.2 It (160 mA) until the battery voltage reached 3.00 V. Then, the discharge capacity (post-storage discharge capacity) at that point was measured for each battery.

Then, the remaining capacity ratio after high-temperature storage was determined for each cell in the same manner as described in Experiment 1 of the foregoing main experiment. The results are shown in Table 5 below.

TABLE 5

| | | Addition of | |
|---|---|---|---|
| | Presence or absence of | chelating agent to | Remaining |
| Battery | inorganic particle layer | negative electrode | capacity ratio |
| R3 | Absent | Yes | 39.0% |
| R4 | | No | 38.3% |

The results shown in Table 5 clearly indicate that Reference Battery R3, in which the chelating agent (ethylenediaminetetraacetic acid) was contained in the negative electrode, showed almost no improvement effect on the remaining capacity ratio over Reference Battery R4, in which no chelating agent was contained. The reason is believed to be that the metal ions that have dissolved away from the positive electrode are deposited predominantly on the negative electrode surface, so the effect of trapping the metal ions is not obtained even if the chelating agent exists inside the negative electrode.

The present invention is suitable for drive power sources for mobile information terminals such as mobile telephones, notebook computers, and PDAs, especially for use in applications that require a high capacity. The invention is also expected to be used for high power applications that require continuous operations under high temperature conditions, such as HEVs and power tools, in which the battery operates under severe operating environments.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A non-aqueous electrolyte secondary battery comprising: a positive electrode containing a positive electrode active material; a negative electrode containing a negative electrode active material; a non-aqueous electrolyte; a separator disposed between the positive electrode and the negative electrode; and an inorganic particle layer containing inorganic particles, the inorganic particle layer disposed between the positive electrode and the separator and/or between the negative electrode and the separator and containing a chelating agent forming a complex with transition metal ions.

2. The non-aqueous electrolyte secondary battery according to claim 1, wherein the inorganic particle layer is formed between the positive electrode and the separator.

3. The non-aqueous electrolyte secondary battery according to claim 2, wherein the inorganic particle layer is formed on a surface of the positive electrode.

4. The non-aqueous electrolyte secondary battery according to claim 1, wherein the amount of the chelating agent is from 0.1 mass % to 2.0 mass % based on the mass of the inorganic particles.

5. The non-aqueous electrolyte secondary battery according to claim 2, wherein the amount of the chelating agent is from 0.1 mass % to 2.0 mass % based on the mass of the inorganic particles.

6. The non-aqueous electrolyte secondary battery according to claim 3, wherein the amount of the chelating agent is from 0.1 mass % to 2.0 mass % based on the mass of the inorganic particles.

7. The non-aqueous electrolyte secondary battery according to claim 1, wherein the inorganic particle layer has a thickness of from 0.5 μm to 4 μm.

8. The non-aqueous electrolyte secondary battery according to claim 2, wherein the inorganic particle layer has a thickness of from 0.5 μm to 4 μm.

9. The non-aqueous electrolyte secondary battery according to claim 3, wherein the inorganic particle layer has a thickness of from 0.5 μm to 4 μm.

10. The non-aqueous electrolyte secondary battery according to claim 4, wherein the inorganic particle layer has a thickness of from 0.5 μm to 4 μm.

11. The non-aqueous electrolyte secondary battery according to claim 5, wherein the inorganic particle layer has a thickness of from 0.5 μm to 4 μm.

12. The non-aqueous electrolyte secondary battery according to claim 6, wherein the inorganic particle layer has a thickness of from 0.5 μm to 4 μm.

13. The non-aqueous electrolyte secondary battery according to claim 1, wherein the positive electrode has a filling density of 3.40 g/cm³ or higher.

14. The non-aqueous electrolyte secondary battery according to claim 2, wherein the positive electrode has a filling density of 3.40 g/cm³ or higher.

15. The non-aqueous electrolyte secondary battery according to claim 3, wherein the positive electrode has a filling density of 3.40 g/cm³ or higher.

16. The non-aqueous electrolyte secondary battery according to claim 4, wherein the positive electrode has a filling density of 3.40 g/cm³ or higher.

17. The non-aqueous electrolyte secondary battery according to claim 5, wherein the positive electrode has a filling density of 3.40 g/cm³ or higher.

18. The non-aqueous electrolyte secondary battery according to claim 6, wherein the positive electrode has a filling density of 3.40 g/cm³ or higher.

19. The non-aqueous electrolyte secondary battery according to claim 7, wherein the positive electrode has a filling density of 3.40 g/cm³ or higher.

20. The non-aqueous electrolyte secondary battery according to claim 8, wherein the positive electrode has a filling density of 3.40 g/cm³ or higher.
